(19) United States
(12) Patent Application Publication
(10) Pub. No.: US 2013/0248117 A1
(43) Pub. Date: Sep. 26, 2013

(54) LAMINATOR WITH IMPROVED HEATING STRUCTURE

(71) Applicant: Chun Yu WU, New Taipei City (TW)

(72) Inventor: Chun Yu WU, New Taipei City (TW)

(73) Assignees: TEX YEAR INDUSTRIES INC., New Taipei City (TW); TEX YEAR BUSINESS MACHINE(SHEN ZHEN)CO.LTD., Shenzhen (CN)

(21) Appl. No.: 13/426,642

(22) Filed: Mar. 22, 2012

(51) Int. Cl. B32B 37/10

(52) U.S. Cl. 156/583.1

(57) ABSTRACT

A laminator with an improved heating structure comprising a machine body, an inlet roller unit, an outlet roller unit and a heating unit, wherein the inlet roller unit, the outlet roller unit and the heating unit are respectively positioned in an internal accommodating space of the machine body, and the heating unit is positioned between the inlet roller unit and the outlet roller group. To carry out lamination, the heating unit is able to directly heat a laminating film, which means directly heating a laminator to avoid waiting for heating, so the aim of improving the utilization efficiency is fulfilled.

### BACKGROUND OF THE PRESENT INVENTION

1. Field of Invention

This invention relates to a laminator with an improved heating structure, in particular to a laminator with an improved heating structure which is able to directly heat a laminator to avoid waiting for heating and therefore improve the utilization efficiency of the laminator.

2. Description of Related Arts At present, the laminator is a common device on the market, which heats and rolls articles such as photos and certificates placed in a laminating film to seal those articles in the laminating film so as to protect those articles well, e.g.: damage of the photos and certificates caused by moisture or tearing is avoided.

See FIGS. 1-3. FIG. 1 is a three-dimensional view of the laminator, FIG. 2 is a sectional view of the laminator, and FIG. 3 is an amplified view of the internal structure of the laminator.

The figure shows a laminator 9, a roller 92 and a heating element 93 positioned in an internal accommodating space 91 of the laminator 9, and the laminator 9 has an inlet 94 and an outlet 95 which are linked with the internal accommodating space 91.

When the laminator 9 works, the heating element 93 heats the laminating film 96 entering from the inlet 94, and the roller 92 rolls the laminating film 96 at the same time to seal articles such as photos and certificates in the laminating film 96.

However, as shown in the figure, the heating element 93 of the traditional laminator is installed on one side of the roller 92, and to carry out lamination, people have to wait for the lamination operation until the heating element 93 heats the roller 92 to the desired temperature, which means that the heating element 93 of the traditional laminator is in direct relationship with the laminating film 96, so people have to wait for heating, which reduces the utilization efficiency of the laminator 9 and is therefore very undesirable.

### SUMMARY OF THE PRESENT INVENTION

A laminator with an improved heating structure comprises a machine body, an inlet roller unit, an outlet roller unit and a heating unit, wherein the machine body comprises an inlet, an internal accommodating space and an outlet, and the three are linked with each other; the inlet roller unit is positioned in the internal accommodating space of the machine body and comprises an inlet upper roller and an inlet lower roller which are configured opposite each other, a first channel is located between the inlet upper roller and the inlet lower roller and leads to the inlet of the machine body; the outlet roller unit is positioned in the internal accommodating space of the machine body and comprises an outlet roller and an outlet lower roller which are configured opposite each other, a second channel is located between the outlet upper roller and the outlet lower roller and leads to the outlet of the machine body; the heating unit is positioned in the internal accommodating space of the machine body and between the inlet roller unit and the outlet roller unit and comprises an upper heating element and a lower heating element which are configured opposite each other, a third channel is located between the upper heating element and the lower heating element and leads to the first and second channels.

Therefore, when the laminator works, the laminating film enters the internal accommodating space from the inlet and passages through the heating unit, then the heating unit directly heats the laminating element, and waiting is not required. In other words, the mentioned structure allows direct lamination heating, waiting for heating is avoided, and thus, the utilization efficiency of the laminator is improved.

The upper and lower heating elements of the heating unit may be a lamp tube or other heating device such as heater band (electric heater band).

### BRIEF DESCRIPTION OF THE DRAWINGS

FIG. 1 is a three-dimensional view of the laminator.

FIG. 2 is a sectional view of the laminator.

FIG. 3 is an amplified view of the internal structure in FIG. 2.

FIG. 4 is a three-dimensional view of a laminator in a preferable embodiment of this invention.

FIG. 5 is a sectional view of a laminator in a preferable embodiment of this invention.

FIG. 6 is an amplified view of the internal structure in FIG. 5.

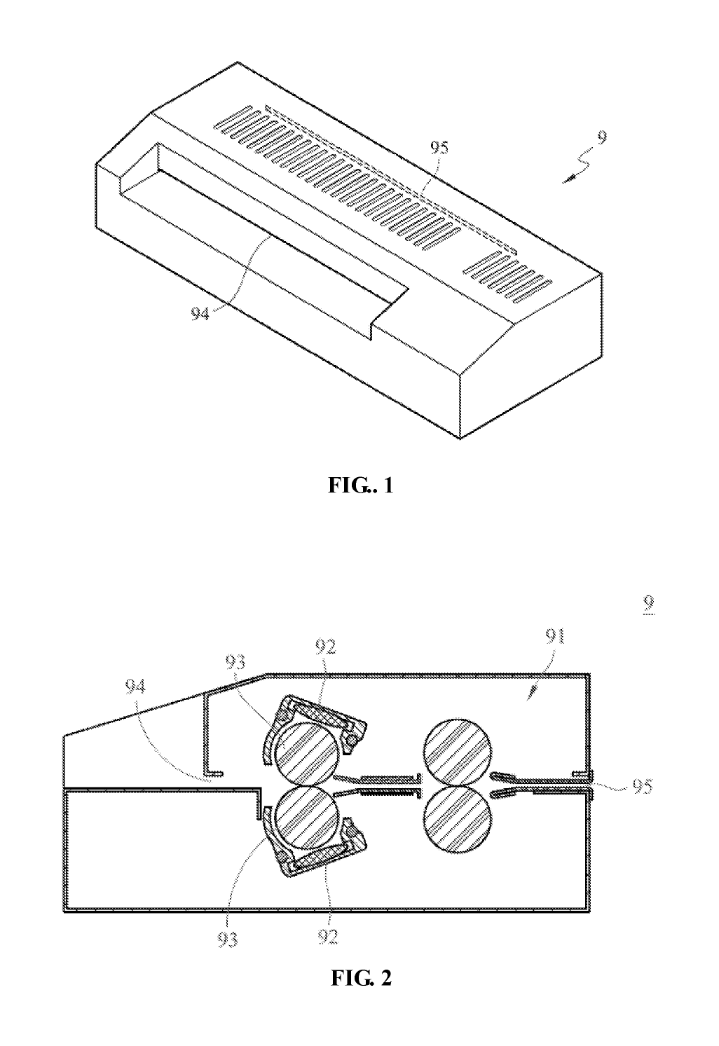

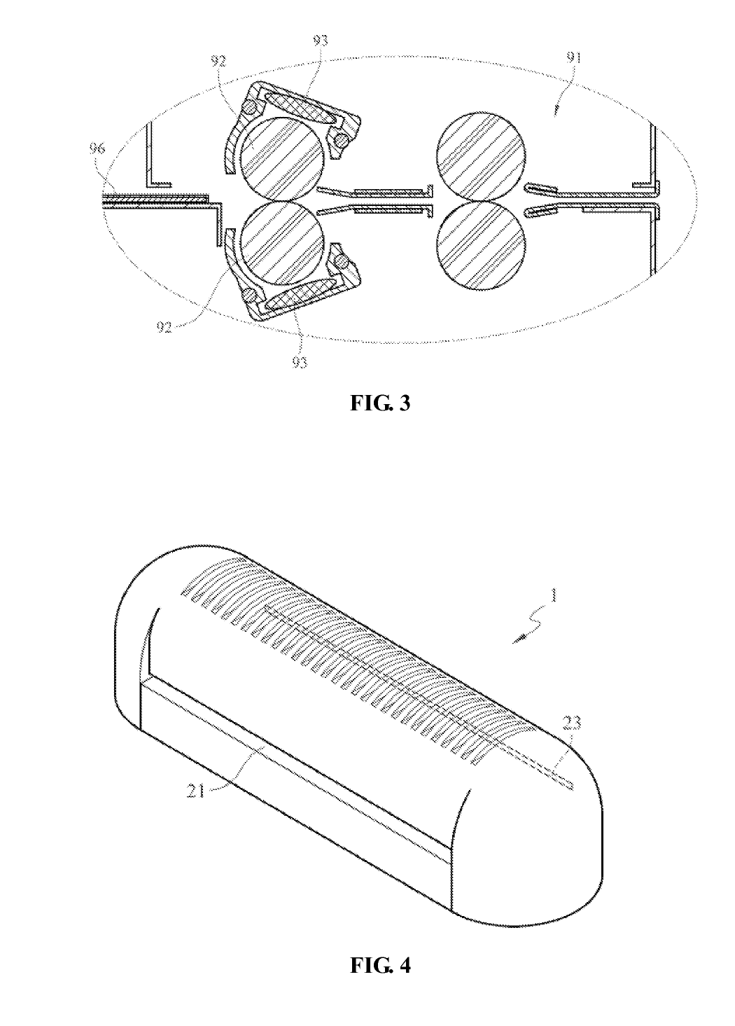

### DETAILED DESCRIPTION OF THE PREFERRED EMBODIMENT

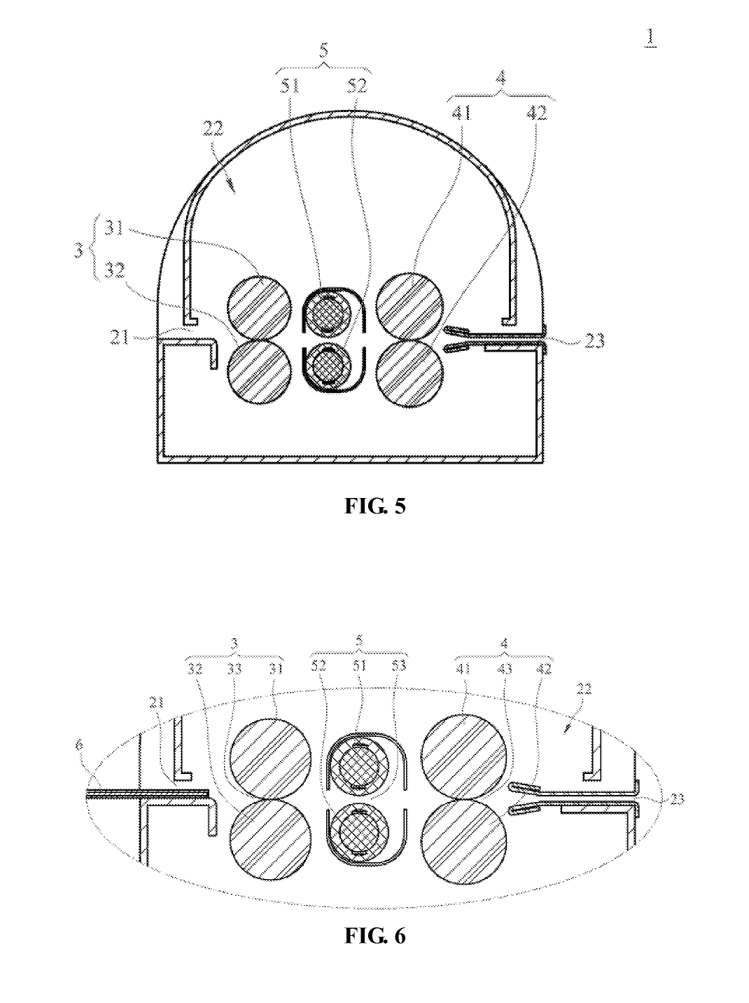

See FIGS. 4-6. FIG. 4 is a three-dimensional view of the laminator in a preferable embodiment, FIG. 5 is a sectional view of the laminator of the preferable embodiment, and FIG. 6 is an amplified view of the internal structure of the laminator in FIG. 5.

The figures illustrate a laminator 1 with an improved heating structure, comprising a machine body 2, an inlet roller unit 3, an outlet roller unit 4 and a heating unit 5, wherein, the machine body 2 comprises an inlet 21, an internal accommodating space 22 and an outlet 23, the three are linked with each other; the inlet roller unit 3 is positioned in the internal accommodating space 22 of the machine body 2 and comprises an inlet upper roller 31 and an inlet lower roller 32 which are configured opposite each other, a first channel 33 is located between the inlet upper roller 31 and the inlet lower roller 32 and leads to the inlet 21 of the machine body 2; the outlet roller unit 4 is positioned in the internal accommodating space 22 of the machine body 2 and comprises an outlet roller 41 and an outlet lower roller 42 which are configured opposite each other, a second channel 43 is located between the outlet upper roller 41 and the outlet lower roller 42 and leads to the outlet 23 of the machine body 2; the heating unit 5 is positioned in the internal accommodating space 22 and between the inlet roller unit 3 and the outlet roller unit 4 and comprises an upper heating element 51 and a lower heating element 52 which are configured opposite each other, a third channel 53 is located between the upper heating element 51 and the lower heating element 53 and leads to the first and second channels 33 and 43.

When the laminator 1 works, the laminating film 6 enters the internal accommodating space 22 from the inlet 21 of the machine body, which means the laminating film 6 is moved by the inlet upper roller 31 and the inlet lower roller 32 of the inlet roller unit 3 from the first channel 33 between the inlet upper roller 31 and the inlet lower roller 32 to the heating unit 5 and moves on the third channel 53 between the upper heating element 51 and the lower heating element 52 of the heating unit 5, at this time the upper heating element 51 and the lower heating element 52 of the heating unit 5 directly heat the laminating film 6, then the laminating film 6 is driven by the outlet upper roller 41 and the outlet lower roller 42 of the outlet roller unit 4 to move on the second channel 43 between the outlet upper roller 41 and the outlet lower roller 42 and rolled by the outlet upper roller 41 and the outlet lower roller 42 at the same time, finally the heated and rolled heating laminating 6 is discharged from the outlet 23 of the machine body 2, and thus, the whole lamination operation is completed.

As mentioned above, the laminating film 6 enters the internal accommodating space 22 from the inlet 21 of the machine body 2 and is directly heated by the upper heating element 51 and the lower heating element 52 of the heating unit 5 when passing through the heating unit 5, therefore, waiting is not required. In other words, the mentioned structure design allows to directly heat the laminator and avoids waiting for heating, and thus, the utilization efficiency of the laminator is improved.

In this embodiment, the upper heating element 51 and the lower heating element 52 of the heating unit 5 are a lamp tube, or other heating devices such as heater band (electric heater band).

What is claimed is:

1. A laminator with an improved heating unit, comprising a machine body, having an inlet, an internal accommodating space and outlet, wherein the inlet, the internal accommodating space and the outlet are linked with each other; an inlet roller unit, positioned in the internal accommodating space and comprising an inlet upper roller and an inlet lower roller which are configured opposite each other, wherein a first channel is located between the inlet upper roller and the inlet lower roller and leads to the inlet; an outlet roller unit, positioned in the internal accommodating space and comprising an outlet upper roller and an outlet lower roller which are configured opposite each other, wherein a second channel is located between the outlet upper roller and the outlet lower roller and leads to the outlet; and a heating unit, positioned in the internal accommodating space and between the inlet roller unit and the outlet roller unit and comprising an upper heating element and a lower heating element which are configured opposite each other, wherein a third channel is located between the upper and lower heating elements and leads to the second channel.

2. A laminator with an improved heating structure according to claim 1, wherein the upper and lower heating elements are a lamp tube.
